(19) United States
(12) Patent Application Publication
(10) Pub. No.: US 2026/0363276 A1
(43) Pub. Date: Nov. 19, 2026

(54) DRY PET FOOD

(71) Applicant: Unicharm Corporation, Shikokuchuo-shi, Ehime (JP)

(72) Inventors: Hayato NISHITANI, Itami-shi (JP); Masaki SHIOTA, Itami-shi (JP); Ikumi MORIKAWA, Itami-shi (JP); Naaya HANZAWA, Itami-shi (JP)

(21) Appl. No.: 19/133,536

(22) PCT Filed: Jan. 25, 2023
(86) PCT No.: PCT/JP2023/002241

§ 371 Date: May 28, 2025

(30) Foreign Application Priority Data
Nov. 30, 2022 (JP) 2022-192270

(51) Int. Cl. A23K 50/42; A23K 10/30; A23K 20/158; A23K 40/10

(52) U.S. Cl. CPC A23K 50/42; A23K 10/30; A23K 20/158; A23K 40/10

(57) ABSTRACT

Dry pet food includes puffed granules having a moisture content of 3% to 12% by mass, in which a content of oils and fats is 10% by mass or greater with respect to a total amount of the dry pet food, and an oil and fat exudation rate on a surface of the dry pet food is 0.06% or greater.

### TECHNICAL FIELD

The present invention relates to dry pet food.

Priority is claimed on Japanese Patent Application No. 2022-192270, filed Nov. 30, 2022, the content of which is incorporated herein by reference.

### BACKGROUND ART

Dry pet food is in high demand as pet food that is regularly fed, from the viewpoint of ease of handling, satisfactory storability, and the like. However, the dry pet food has a high proportion of powder ingredients with respect to pet food having a high moisture content, such as soft dry food, semi-moist food, or wet food in many cases, and thus may have poor palatability.

In pet food, various ideas have been introduced so that pets can enjoy eating, that is, palatability improves.

For example, Patent Document 1 discloses animal food containing a grain-based shell component and a soft internal component including a lipid component, in which the palatability is improved by making the animal food have a double structure in which the soft internal component is completely surrounded by the shell component.

### CITATION LIST

### Patent Document

Patent Document 1: Japanese Patent No. 4689932

### SUMMARY OF INVENTION

### Technical Problem

However, the pet food with ingenuity may have a significantly different configuration or composition from the pet food that is regularly fed. There is a problem in that a pet owner has a concern that the pet food, in which the palatability is improved by artificial ingenuity, affects the health of the pet.

The present invention has been made in consideration of the above-described circumstances, and an object thereof is to provide dry pet food with satisfactory palatability, in which the composition and the configuration are not significantly different from typical pet food and the palatability is improved.

### Solution to Problem

In order to achieve the above-described object, the present invention has the following aspects.

[1] Dry pet food including: puffed granules having a moisture content of 3% to 12% by mass, in which a content of oils and fats is 10% by mass or greater with respect to a total amount of the dry pet food, and an oil and fat exudation rate on a surface of the dry pet food is 0.06% or greater under the following measurement conditions.

### (Measurement Conditions)

(1) A mass of filter paper having a filter paper area of 420×600 is measured.

(2) The filter paper is spread and placed on a plastic tray having outer dimensions of a width W of 705 mm, a depth D of 462 mm, and a height H of 57 mm.

(3) 500 g of the dry pet food is evenly spread and placed on the filter paper spread on the tray.

(4) The tray on which the dry pet food is placed is allowed to stand in an electric oven heated to 37 °C for 30 minutes.

(5) The tray is taken out from the electric oven, and the mass of the filter paper is measured.

(6) The oil and fat exudation rate on the surface of the dry pet food is calculated from the following calculation formula.

Oil and fat exudation rate (%) on surface of dry pet food=[(mass of filter paper measured in (5))/(mass of filter paper measured in (1))]×100

[2] The dry pet food according to [1], in which the puffed granules include granules having a surface with an arithmetic average surface roughness Sa of 14 μm or greater, which is measured using an L filter having a nesting index of 0.25 mm.

[3] The dry pet food according to [1] or [2], in which the oils and fats have a melting point of 30 °C to 40 °C.

[4] The dry pet food according to any one of [1] to [3], in which a substance that exudes on the surface of the dry pet food contains at least one selected from the group consisting of a triglyceride and a protein.

[5] The dry pet food according to any one of [1] to [4], in which the dry pet food contains 3.0% by mass or greater of a powdery palatability improver with respect to the total amount of the dry pet food.

[6] The dry pet food according to claim 1, in which an L* value in an L*a*b* color system is in a range of 21 to 33.

[7] The dry pet food according to [2], in which the dry pet food contains 30% by mass or greater of wheat flour with respect to the total amount of the dry pet food.

### Advantageous Effects of Invention

According to the present invention, it is possible to provide dry pet food with satisfactory palatability, in which the composition and the configuration are not significantly different from typical pet food and the palatability is improved.

### BRIEF DESCRIPTION OF DRAWINGS

FIG. 1 A cross-sectional view showing an example of a device of producing dry pet food according to the present embodiment.

FIG. 2 A cross-sectional view for describing a method of producing pet food granules using the device of FIG. 1.

FIG. 3 An infrared absorption spectrum of an ethyl acetate extract of a substance that has exuded on a surface of the dry pet food according to the present embodiment.

FIG. 4 An example of an infrared absorption spectrum of a triglyceride.

FIG. 5 An infrared absorption spectrum of an ethyl acetate extract of a substance that has exuded on the surface of the dry pet food according to the present embodiment.

FIG. 6 An example of an infrared absorption spectrum of a protein.

### DESCRIPTION OF EMBODIMENTS

In the present specification, the term “pet” refers to an animal raised by a person. In a narrower sense, pets are animals that are kept and loved by their owners. In addition, the term “pet food” refers to feed for pets. Pet food according to the present invention can be sold as “feed for animals” or an “animal feed”.

In the present specification, the term “palatability” is an index of whether or not a pet favors to eat, and is affected by the texture, the taste, the odor, and the like.

In the present specification, the moisture content ratio (% by weight) of pet food is determined by a normal pressure heating and drying method. The moisture content ratio determined by this method also includes the moisture in the ingredients.

### (Normal Pressure Heating and Drying Method)

The weight of an aluminum weighing can (W1 grams) is measured in advance as a constant weight value. A sample is introduced into this aluminum weighing can, and the weight (W2 grams) is weighed. Next, the sample is dried under the conditions of 135 °C for 2 hours by using a forced circulation type warm air dryer. After the sample is left to cool in a dry atmosphere (in a silica gel desiccator), the weight (W3 grams) is weighed. The moisture content ratio is determined from each of the obtained weights by using the following equation.

Moisture content ratio (unit: % by weight)=(W2−W3)÷(W2−W1)×100

### [Method of Measuring Hardness]

In the present specification, the hardness (breaking hardness) of the food granules is a value obtained by the following measuring method.

A breaking stress in a case where the pet food granules are compressed at a constant compression speed is measured under the following conditions, using a compression tester (texture analyzer, model number: EZ-SX, manufactured by Shimadzu Corporation). Plunger: conical plunger having diameter of 10 mm, platform: flat plate, compression speed: 60 mm/min, lowest point of plunger: 2.25 mm (compression distance), measurement temperature: 25 °C

Specifically, one pet food granule to be measured is placed on a flat plate, and the stress is measured while the plunger is pressed vertically from directly above the granule at a constant speed. The peak value (maximum value) of the stress is read as the value of the breaking stress. The measurement is repeatedly performed for 10 granules to determine the average value. The unit of the numerical value of the breaking hardness is converted into Newton (N) by multiplying the numerical value of the breaking stress (unit: kgw) to be measured by the compression tester by 9.8.

The hardness of the pet food granules is a value measured immediately after the pet food product is opened within 30 days from the manufacturing date, or a value measured under the same conditions.

### [Arithmetic Average Surface Roughness Sa]

In the present specification, as an example of calculation, the arithmetic average surface roughness Sa is calculated for the surface of the food granules by performing surface observation of the food granules (magnification: 40 times, observation visual field area: 19 to 20 mm²) using a non-contact three-dimensional shape measuring instrument VR-3200 (manufactured by KEYENCE CORPORATION, using L filter with nesting index of 0.25 mm).

In the present specification, L*, a*, and b* are values represented by the L*a*b* color system measurement (JIS Z 8729) standardized by the International Commission on illumination (CIE). In L*a*b*, L* represents brightness of a color as a diffusion color in a black direction in a case of a value of 0 and in a white direction in a case of a value of 100. a*b* represents the chromaticity, and a* represents a hue between red and green, in which a negative value represents a hue in a green direction and a positive value represents a hue in a red direction. b* represents a hue between yellow and blue, in which a negative value represents a hue in a blue direction, and a positive value represents a hue in a yellow direction. Further. L*a*b* is expressed as three-dimensional coordinates.

The expression “comprehensive nutritional food” is a product that is intended to be fed to a dog or a cat as a main daily meal among pet foods, and is a nutritionally balanced product that can maintain health at a designated growth stage with only the pet food and water. As a standard for the comprehensive nutritional food, for example, a standard determined by the Association of American Feed Control Officials (AAFCO) may be used.

Further, in the present specification, “comprehensive nutritional food” may be food that satisfies a standard of any stage of “puppy/kitten stage/growth stage or growth”, “adult dog stage and adult cat stage/maintenance stage or maintenance”, or “pregnancy stage/lactation stage”, regardless of the growth stage, or may be food that satisfies all three stages, which is referred to as “all growth stages” or “for all stages”.

In the present specification, the term “palatability” is an index of whether or not a pet favors to eat, and is affected by the texture, the taste, the odor, and the like.

### <Dry Pet Food>

The dry pet food according to the present embodiment includes puffed granules having a moisture content of 3% to 12% by mass. The moisture content of the puffed granules is preferably in a range of 3.0% to 10.0% by mass and more preferably in a range of 5.0% to 8.0% by mass.

In the dry pet food according to the present embodiment, the content of the oils and fats is 10% by mass or greater, preferably in a range of 10% to 15% by mass, and more preferably in a range of 10.5% to 14% by mass with respect to the total amount of the dry pet food.

In a case where the content of the oils and fats is 10% by mass or greater, the palatability is likely to be satisfactory even in a case where the composition and the configuration of the dry pet food are typical.

In the dry pet food according to the present embodiment, the oil and fat exudation rate on the surface of the dry pet food under the following measurement conditions (hereinafter, also referred to as “oil and fat exudation rate at 37 °C”) is 0.06% or grater, preferably 0.07% or greater, and more preferably 0.08% or greater. In a case where the oil and fat exudation rate at 37 °C is 0.06% or greater, the palatability is likely to be satisfactory even in a case where the composition and the configuration of the dry pet food are typical.

### (Conditions for Measuring Oil and Fat Exudation Rate at 37 °C)

(1) A mass of filter paper having a filter paper area of 420×600 cm² is measured.

(2) The filter paper is spread and placed on a plastic tray having outer dimensions of a width W of 705 mm, a depth D of 462 mm, and a height H of 57 mm.

(3) 500 g of the dry pet food is evenly spread and placed on the filter paper spread on the tray.

(4) The tray on which the dry pet food is placed is allowed to stand in an electric oven heated to 37 °C for 30 minutes.

(5) The tray is taken out from the electric oven, and the mass of the filter paper is measured.

(6) The oil and fat exudation rate on the surface of the dry pet food is calculated from the following calculation formula.

Oil and fat exudation rate (%) on surface of dry pet food=[(mass of filter paper measured in (5))/(mass of filter paper measured in (1)]×100

In the dry pet food according to the present embodiment, the oil and fat exudation rate on the surface of the dry pet food under the following measurement conditions thereinafter, also referred to as “oil and fat exudation rate at 25 °C”) is preferably 0.02% or greater, more preferably 0.03% or greater, and still more preferably 0.04% or greater.

In a case where the oil and fat exudation rate at 25 °C is 0.02% or greater, the palatability is likely to be satisfactory even in a case where the composition and the configuration of the dry pet food are typical.

### (Conditions for Measuring Oil and Fat Exudation Rate at 25′C)

(1) A mass of filter paper having a filter paper area of 420×600 cm² is measured.

(2) The filter paper is spread and placed on a plastic tray having outer dimensions of a width W of 705 mm, a depth D of 462 mm, and a height H of 57 mm.

(3) 500 g of the dry pet food is evenly spread and placed on the filter paper spread on the tray.

(4) The tray on which the dry pet food is placed is allowed to stand at room temperature (25 °C) for 30 minutes.

(5) The mass of the filter paper is measured.

(6) The oil and fat exudation rate on the surface of the dry pet food is calculated from the following calculation formula.

Oil and fat exudation rate (%) on surface of dry pet food=[(mass of filter paper measured in (5))/(mass of filter paper measured in (1))]×100

The dry pet food according to the present embodiment enhances the palatability by improving the amount of oils and fats contained in the food granules. A large amount of oils and fats remain on the surface of the food granules, and a synergistic effect between the oils and fats and the palatable component derived from the protein attached to the surface is generated. Therefore, the impact in the start of eating is large for a pet, and biting of the pet is enhanced. Meanwhile, the owner can feel the specialness because the appearance of the pet food gives an impression that the flavor has soaked into the surface of the food granules and biting of the pet is also enhanced as compared with dry pet food of the related art.

It is preferable that the dry pet food according to the present embodiment is formed such that the puffed granules include granules having a surface with an arithmetic average surface roughness Sa which is measured using an L filter having a nesting index of 0.25 mm of 14 μm or greater.

In a case where the puffed granules include granules having a surface with an arithmetic average surface roughness Sa of 14 μm or greater, the oils and fats are easily drawn into the inside of the food granules, and the absorption amount of the oils and fats is likely to be increased while the oils and fats are allowed to remain sufficiently on the surface of the food granules.

The puffed granules including granules having a surface with an arithmetic average surface roughness Sa of 14 μm or greater can have a soft center portion having an exposed cross section and a peripheral portion having a higher hardness than that of the center portion, for example, by cutting a pet food material discharged from an extruder (extrusion molding machine) after the material is puffed.

The upper limit of the arithmetic average surface roughness Sa is not particularly limited, but in a case where the food granules are coated with the oils and fats, it is difficult to uniformly coat the food granules in a case where the arithmetic average surface roughness Sa is extremely large. For example, Sa is preferably 30 μm or less and more preferably 25 μm or less.

In the dry pet food according to the present embodiment, the melting point of the oils and fats is preferably in a range of 30′C to 40 °C, more preferably in a range of 35 °C to 40 °C and still more preferably in a range of 38 °C to 39 °C.

In a case where the melting point of the oils and fats is in the above-described preferable ranges, the oils and fats are likely to be dissolved by the tongue of a pet (particularly, a cat), and the palatability is likely to be further enhanced. In addition, since the oils and fats are difficult to dissolve at room temperature, the storage stability is likely to be enhanced while the palatability is increased.

The substance that exudes on the surface of the food granules in the dry pet food according to the present embodiment contains preferably at least one selected from the group consisting of a triglyceride and a protein and more preferably a triglyceride and a protein.

In a case where the substance that exudes on the surface of the food granules contains a triglyceride and/or a protein, the palatability of the dry pet food is more likely to be increased.

The dry pet food according to the present embodiment contains a powdery palatability improver in an amount of preferably 3.0% by mass or greater, more preferably 4.0% by mass or greater, and still more preferably 5.0% by mass or greater with respect to the total amount of the dry pet food.

In a case where the content of the powdery palatability improver is in the above-described preferable ranges, the amount of the powdery palatability improver present on the surface of the food granules is likely to increase. Therefore, the oils and fats are likely to be suppressed from penetrating into the food granules, the oils and fats are likely to remain on the surface of the food granules, and the palatability is likely to be increased.

In the dry pet food according to the present embodiment, the L* value in the L*a*b* color system is preferably in a range of 21 to 33, more preferably in a range of 22 to 32, and still more preferably in a range of 23 to 31.

In a case where the L* value in the L*a*b* color system is in the above-described preferable ranges, the owner is likely to feel the specialness because the appearance of the pet food gives an impression that the flavor has soaked into the surface of the food granules and biting of the pet is also enhanced as compared with dry pet food of the related art.

In the dry pet food according to the present embodiment, the b* value in the L*a*b* color system is preferably in a range of 12 to 23, more preferably in a range of 13 to 22, and still more preferably in a range of 14 to 21.

In a case where the b* value in the L*a*b* color system is in the above-described preferable ranges, the owner is likely to feel the specialness because the appearance of the pet food gives an impression that the flavor has soaked into the surface of the food granules and biting of the pet is also enhanced as compared with dry pet food of the related art.

The puffed granules of the dry pet food according to the present embodiment include granules having a surface with an arithmetic average surface roughness Sa of 14 μm or greater, which is measured using an L filter having a nesting index of 0.25 mm, and the content of wheat flour is preferably 30% by mass or greater, more preferably 35% by mass or greater, and still more preferably 40% by mass or greater with respect to the total amount of the dry pet food.

In a case where the puffed granules include granules having a surface with an arithmetic average surface roughness Sa of 14 μm or greater and the content of the wheat flour is in the above-described preferable ranges, the oils and fats are likely to exude on the surface of the food granules, and the palatability is likely to be improved.

In the dry pet food according to the present embodiment, the hardness of the food granules (the granular substance of the mixture of ingredients) is preferably in a range of 10 to 90 N, more preferably in a range of 15 to 70 N. and still more preferably in a range of 20 to 50 N. In a case where the hardness of the food granules is in the above-described preferable ranges, the palatability is likely to be improved.

The shape of the pet food as comprehensive nutritional food according to the present embodiment is not particularly limited as long as the pet food has a shape suitable for a pet to eat.

For example, any shape such as spherical, ellipsoidal (grid-like), pellet-shaped, cylindrical, polygonal columnar, hexahedral (plate-shaped), clover-shaped, heart-shaped, star-shaped, or cross-shaped can be applied.

Further, in regard to the size of food granules, the food granules may have a small granule shape such that a pet can eat the food in one bite or may have a large granule shape such that a pet can bite into the food a plurality of times.

For example, pellet-shaped (granular or lump-shaped) granules in which the minor axis and the major axis in a case where the food granules placed on a water platform are viewed from above are in a range of 3 to 25 mm and the thickness from a lower surface (lower end) to an upper surface (upper end) of the food granules on the water platform is in a range of 2.5 to 20 mm are preferable, pellet-shaped granules in which the minor axis and the major axis are in a range of 3 to 13 mm and the thickness is in a range of 2.5 to 9 mm are more preferable, and pellet-shaped granules in which the minor axis and the major axis are in a range of 6 to 12 nm and the thickness is in a range of 2.5 to 8 mm are still more preferable. In a case where the food granules have this shape, the hardness in a case of adjustment to a predetermined moisture content ratio in a heat treatment and a drying treatment in a step of producing the pet food granules is likely to be adjusted to be in a preferable range.

Pet food can be classified into comprehensive nutritional food provided as a regular meal, between-meal snacks provided as snacks, therapeutic food having particular ingredients used for pets with diseases, and food for other purposes, and it is appropriate that the pet food of the present invention is comprehensive nutritional food.

### <<Ingredients>>

As ingredients of the pet food as comprehensive nutritional food according to the present embodiment, known powder ingredients and known liquid ingredients in the production of pet food can be used.

Specific examples of the powder ingredient include grains (corn, wheat, wheat flour, wheat bran, rice, bread crumbs, barley, oats, rye, and the like), tubers (sweet potato, potato, and the like), beans (whole soybeans and the like), starches (wheat starch, corn starch, rice starch, potato starch, tapioca starch, sweet potato starch, sago starch, processed starch, and the like), vegetable proteins (corn gluten meal, wheat protein, bean protein, rice protein, tuber protein, and the like), meat (livestock meat and game meat such as beef, pork, sheep, deer, and rabbit; poultry meat such as chicken, turkey, quail, and fowl; and meals (chicken meal, pork meal, beef meal, and mixed meal thereof)), seafood (fish such as tuna, bonito, and horse mackerel; crustaceans such as shrimp and crab; mollusks such as octopus and squid; shellfish such as scallops and turban shells; fish extracts; dried bonito, and meals (fish meal)), vegetables, seeds, mushrooms, eggs, sugars, milks, and additives (vitamins, minerals, amino acids, flavoring ingredients, powdery palatability improvers, fibers, colorants, phosphates, pH adjusters, seasonings, antioxidants, trehalose, and the like).

The meal denotes powder obtained by compressing and finely crushing meat or seafood.

More specific examples of the powdery palatability improver include an animal ingredient extract, a vegetable ingredient extract, a yeast extract, a dried product of yeast, and a plant and animal-derived protein enzymatic decomposition product.

Specific examples of the liquid ingredient (including semi-solid ingredient) include water, oils and fats (animal oils and fats such as chicken oil, lard, tallow, dairy fat, and fish oil; and vegetable oils and fats such as olive oil, cacao oil, palm oil, palm kernel oil, coconut oil, coconut oil, and camellia oil), liquid palatability improvers, liquid sugar, moisturizing agents, preservatives, emulsifiers, fragrances, and colorants.

Examples of the formulation of the dry pet food according to the present embodiment include 30% to 50% by mass of wheat flour, 0% to 20% by mass of grains other than wheat flour, 10% to 30% by mass of meat, 5% to 20% by mass of animal oils and fats, 5% to 15% by mass of yeasts, 2% to 10% by mass of seafood, and 2% to 10% by mass of additives such as vitamins, minerals, and amino acids.

The dry pet food according to the present embodiment is preferably coated with a coating agent and more preferably coated multiple times.

Examples of the coating agent include oils and fats and powdery palatability improvers.

The oils and fats of the coating agent may be vegetable oils and fats or animal oils and fats. The oils and fats may be used alone or in combination of two or more kinds thereof. The oils and fats may be oils and fats that are in a liquid state at room temperature or oils and fats that are in a solid state at room temperature. The oils and fats are used after being heated as necessary in order to obtain oils and fats in a liquid state.

From the viewpoint of easily obtaining high palatability, it is preferable that the oils and fats include animal oils and fats. Examples of the animal oils and fats include chicken oil, lard, beef tallow, and dairy fat. The animal oils and fats may be used alone or in combination of a plurality of kinds thereof.

As the powdery palatability improver, at least one selected from the group consisting of an animal ingredient enzymatic decomposition product, a vegetable ingredient enzymatic decomposition product, an animal and vegetable ingredient extract, and a yeast extract can be used.

Examples of the animal ingredient enzymatic decomposition product include an enzymatic decomposition product of chicken meat, an enzymatic decomposition product of chicken liver (hereinafter, also referred to as chicken liver), an enzymatic decomposition product of pork, an enzymatic decomposition product of pork liver, an enzymatic decomposition product of beef, an enzymatic decomposition product of beef liver, and an enzymatic decomposition product of seafood.

Examples of the vegetable ingredient enzymatic decomposition product include an enzymatic decomposition product of beans (soybeans and the like) and an enzymatic decomposition product of tubers (potatoes and the like).

Examples of the yeast extract include a beer yeast extract, a bread yeast extract, and a torula yeast extract.

The palatability improver may be used alone or in combination of two or more kinds thereof.

### <Method of Producing Dry Pet Food>

As a method of producing the pet food according to the present embodiment, a known method can be used without particular limitation as long as the configuration of the present embodiment is employed. Examples of the known method include a method of producing pet food, including a granulating step, a drying step, and a coating step in order.

### [Granulating Step]

In the granulating step, the mixture of ingredients is granulated to obtain food granules. Known methods can be used as a method of mixing ingredients to obtain a mixture of the ingredients and a method of forming (granulating) the mixture of the ingredients in a granular shape.

For example, a method of producing the puffed granules using an extruder can be suitably used. As the method of producing puffed granules using an extruder, for example, a method described in “Small Animal Clinical Nutrition, 5th edition” (edited by Michael S. Hand, Craig D. Thatcher, Rebecca L Remillard, Philip Roudebusg, and Bruce J. Novotny, published by Mark Morris Associates; 2014; pp. 209 to 215) can be applied.

An example of the method of producing the puffed granules using an extruder will be described. First, among the ingredients of the puffed granules, ingredients other than external additives are pulverized as necessary and mixed. The ingredients may be mixed while being pulverized using a grinder or the like. Further, water (which is not included in the ingredient composition) is added thereto as necessary to obtain a mixture of the ingredients.

The obtained mixture of the ingredients is put into the extruder, heated, pressed, and then extruded from an outlet. The outlet is provided with a plate in which a hole having a predetermined shape is formed and a cutter cutting the mixture of the ingredients extruded from the plate to have a predetermined length (thickness). At the same time with the extrusion of the mixture of the ingredients from the hole of the plate and the formation of the mixture in a predetermined shape by cutting the mixture using a cutter, the mixture of the ingredients is released to the normal pressure from the pressurized state so that water vapor in the mixture of the ingredients expands, and the mixture of the ingredients is puffed, thereby obtaining porous granules.

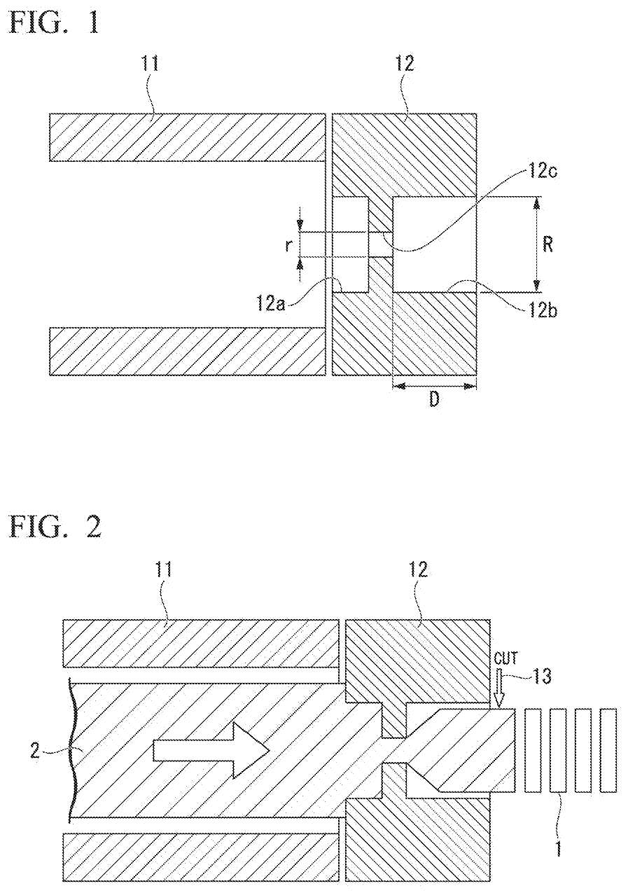

In a case of producing puffed granules including granules having a surface with an arithmetic average surface roughness Sa of 14 μm or greater, which is measured using an L filter having a nesting index of 0.25 mm, for example, a device shown in FIG. 1 can be used. FIG. 1 is a cross-sectional view schematically showing a main pail of the device. FIG. 2 is a cross-sectional view for describing a method of producing pet food granules using the device shown in FIG. 1.

In the figures, the reference numeral 1 denotes a food granule, the reference numeral 2 denotes a kneaded material, and the reference numeral 11 denotes an extruder. The extruder 11 heats and kneads the mixture of ingredients to discharge the kneaded material 2. A die plate 12 for discharging the kneaded material 2 in a rod shape is provided at a discharge port of the extruder 11.

In addition, although not shown, a cutter that cuts the kneaded material 2 into a predetermined length is provided in the vicinity of the discharge port of the die plate 12. The reference numeral 13 in FIG. 2 denotes a cutting position by the cutter. For example, a rotary blade is used as the cutter.

The die plate 12 includes a first opening portion 12a formed on the extruder 11 side and a second opening portion 12b provided on the cutter side. In a flow path that allows the first opening portion 12a and the second opening portion 12b to communicate with each other, the first opening portion 12a gradually decreases in diameter in a direction toward the second opening portion 12b and is connected to the second opening portion 12b via a minimum inner diameter portion 12c. The inner diameter of the second opening portion 12b is constant. The minimum inner diameter of the flow path is denoted as r, and the inner diameter of the second opening portion 12b is denoted as R.

As shown in FIG. 2, the kneaded material 2 which has been at a high temperature and a high pressure in the extruder 11 passes through the flow path in the die plate 12 from the first opening portion 12a of the die plate 12, is extruded under normal pressure from the minimum inner diameter portion 12c, and is puffed in the second opening portion 12b. Further, the food granules 1 are formed (granulated) by being sufficiently puffed while traveling toward the outlet of the second opening portion 12b (the discharge port of the die plate 12), starting to be contracted in the second opening portion 12b, being discharged from the discharge port of the die plate 12, and being cut by a cutter (cutting position 13).

The kneaded material 2 is puffed so that air bubbles are formed inside, and the kneaded material 2 is cut with a cutter after the puffing is completely finished and the kneaded material 2 starts to be contracted. Therefore, holes formed by cutting air bubbles are present on the cut surface.

The shape of the food granules 1 formed as described above is a columnar shape obtained by cutting the rod-like kneaded material 2 with a plane perpendicular to the length direction. The arithmetic average surface roughness Sa of the cut surface (the upper surface and the lower surface perpendicular to the thickness direction of the columnar structure) perpendicular to the length direction is greater than that of a side surface parallel to the length direction.

For example, in a case where the food granules 1 are viewed in a direction perpendicular to the length direction, the minor axis and the major axis are preferably in a range of 3 to 25 mm, and the thickness from the lower surface (the lower end in the thickness direction) to the upper surface (the upper end in the thickness direction) of the food granules on the water platform is preferably in a range of 2.5 to 20 mm, the minor axis and the major axis are more preferably in a range of 3 to 13 mm, the thickness is more preferably in a range of 2.5 to 9 mm, the minor axis and the major axis are still more preferably in a range of 6 to 12 mm, and the thickness is still more preferably in a range of 2.5 to 8 mm.

In the die plate 12, the inner diameter R of the second opening portion 12b is 3.5 times or more (R/r≥3.5) the minimum inner diameter r of the flow path in the die plate 12. The tipper limit of R/r representing the ratio of the inner diameter is preferably 7 or less and more preferably 6.5 or less from the viewpoint of the formability of the food granules.

In a case where the ratio of R/r is 3.5 or greater, the kneaded material 2 can be sufficiently puffed, and thus the air bubbles formed inside the kneaded material are large and the holes formed in the cut surface are large. That is, since the surface roughness of the cut surface of the food granules 1 is increased, food granules having a surface with Sa of 14 μm or greater are obtained.

The size of the minimum inner diameter r is designed according to the size of the food granules to be obtained.

The shape of the outlet of the minimum inner diameter portion 12c is designed according to the shape of the food granules to be obtained.

A distance D that the kneaded material 2 travels from the minimum inner diameter portion 12c to the second opening portion 12b is a length required for the kneaded material 2 traveling in the second opening portion 12b to start to be contracted after the kneaded material 2 is sufficiently puffed.

For example, it is preferable that the minimum inner diameter r of the flow path is in a range of 3 to 10 mm, the inner diameter R of the second opening portion 12b is in a range of 9 to 40 mm, and the distance D is in a range of 10 to 22 mm. It is more preferable that r is in a range of 3 to 6 mm, R is in a range of 12 to 26 mm, and D is in a range of 15 to 20 mm.

### [Drying Step]

The granules to be obtained in the above-described manner are dried as necessary until a predetermined moisture content is obtained to obtain puffed granules (food granules). In a case where dry type food granules are produced, the drying step is indispensable.

For example, the moisture content of the granules to be discharged from the extruder is in a range of 10% to 30% by mass. In a case where the granules have such a moisture content, satisfactory formability is likely to be obtained.

The temperature of the granules to be discharged from the extruder depends on the heating temperature in the extruder. For example, the temperature thereof may be in a range of 90 °C to 150 °C.

As a method of drying the granules discharged from the extruder, a known method can be appropriately used. Examples of the known method include a hot air drying method of drying granules by blowing hot air to the granules, a vacuum drying method, and a method of frying granules in oil. For example, a hot air drying method using a conveyor type hot air dryer is preferable. The drying conditions (the temperature and the time) may be conditions for increasing the temperature of granules to 100 °C or higher to evaporate the moisture in the granules without thermal denaturation of the components of the granules and adjusting the moisture content of the granules to a desired value. For example, in a case where the granules are dried by a hot air dryer, the temperature of the hot air coming into contact with the granules is preferably in a range of 100 °C to 140 °C and more preferably in a range of 100 °C to 110 °C. The drying time is not particularly limited, and the granules are dried for about 5 to 20 minutes.

After the drying, the pet food may be further coated with a coating agent such as oils and fats or a powder palatability improver.

A coating method is not particularly limited, and the pet foot can be coated according to a vacuum coating method. The vacuum coating method is a method of reducing the pressure in a state where the heated food granules and the coating agent are in contact with each other or adhere to each other and slowly releasing the food granules to the atmosphere. The coating agent may be in the form of a liquid or powder. The palatability (biting property) for a pet can be improved by performing the coating described above. Further, in the present embodiment, it is preferable that the coating is performed multiple times.

### EXAMPLES

Hereinafter, the present invention will be described in more detail based on examples, but the present invention is not limited to these examples.

### Example 1: Production of Dry Pet Food

Pet food granules were produced using the device shown in FIGS. 1 and 2.

The minimum inner diameter r of the flow path in the die plate 12 was set to 4.5 mm, the inner diameter R of the second opening portion was set to 18 mm, and the distance D was set to 18 mm. The ratio of R/r was 4. Both the outlet of the minimum inner diameter portion 12c and the outlet of the second opening portion 12b were circular.

First, using a preconditioner, each ingredient excluding animal oils and fats and some of the palatability improvers was mixed in the formulation listed in Table 1, water and steam were added thereto, and the mixture was subjected to a heat treatment at 90 °C to 100 °C for 3 minutes, thereby obtaining a mixture of ingredients.

Next, the obtained mixture of ingredients was supplied to an extruder, and subjected to a heat treatment at 120 °C to 135 °C for 30 seconds while being kneaded, and the kneaded material was discharged from a die plate and cut, thereby forming cylindrical food granules having a diameter of 10 mm and a thickness of 4.5 mm.

Thereafter, the obtained food granules were dried with a dryer at about 100 °C to 110 °C for about 15 minutes to adjust the moisture content to 6% by mass.

After the drying, the animal oils and fats and some of the palatability improvers were subjected to a coating treatment twice, thereby obtaining pet food granules (1).

### Comparative Example 1: Production of Dry Pet Food

Pet food granules (2) were obtained in the same manner as in Example 1 except that the formulation of ingredients was changed as listed in Table 1 and the animal oils and fats and some of the palatability improvers were subjected to a coating treatment only once.

TABLE 1

| | |
|---|---|
| | Comparative |
| Example 1 | Example 1 |

| | |
|---|---|
| Formulation | mass (%) |

| | | |
|---|---|---|
| Grains (wheat flour) | 40 | 10 |
| Grains (other grains) | 10 | 40 |
| Meat | 20 | 25 |
| Animal oils and fats | 10 | 10 |
| Yeasts | 10 | 5 |
| Seafood | 5 | 5 |
| Vitamins, minerals, and amino acids | 5 | 5 |

### [Evaluation of Oil and Fat Exudation Rate]

The oil and fat exudation rate on the surface of the dry pet food was measured for the pet food granules (1) and (2) according to the following measurement conditions. The results are listed in Table 2.

### (Measurement Conditions)

(1) The mass of filter paper (product name: ADVANTEC qualitative filter paper No. 1600×600; manufactured by Toyo Roshi Kaisha, Ltd.) having a filter paper area of 420×600 cm² was measured using an electronic balance (product name: METTLER AE200; manufactured by DKSH Holding AG).

(2) The filter paper was spread and placed on a plastic tray (product name: tray container; manufactured by Gifu Plastic Industry Co., Ltd.) having outer dimensions of a width W of 705 mm, a depth D of 462 mm, and a height H of 57 mm.

(3) Pet food granules (1) or (2) in the amount listed in Table 2 were evenly spread and placed on the filter paper spread on the tray.

(4) The tray on which the dry pet food was placed was allowed to stand for 30 minutes in an electric oven heated to 37 °C or allowed to stand at room temperature (25 °C) for 30 minutes.

(5) The tray was taken out from the electric oven or the tray that had been allowed to stand at room temperature (25 °C) for 30 minutes was used to measure the mass of the filter paper.

(6) The oil and fat exudation rate on the surface of the dry pet food was calculated from the following calculation formula.

Oil and fat exudation rate (%) on surface of dry pet food=[(mass of filter paper measured in (5))/(mass of filter paper measured in (1))]×100

### [Evaluation of Palatability]

The pet food granules (1) or (2) were used as pet food P, and commercially available pet food (granular pet food formed of pet food granules in which the inside of a grain-based outer shell was filled with cream; Sheba (registered trademark) Duo (registered trademark)) was used as pet food Q. The palatability was evaluated by a method of comparing the amount of food intake for the pet food P and the pet food Q. Twenty cats were used as monitors and subjected to a test for 2 days.

On the first day, one of the pet foods P and Q was fed from the left and the other was fed from the right at the same time with a predetermined feeding amount for one cat. In a case where the cat completely ate one or the other or after 30 minutes, the amount of pet fool that the cat ate was measured.

A ratio (P:Q. P+Q=100%) of the amount of food intake for the pet food P to the amount of food intake for the pet food Q with respect to the total mass of the pet food eaten by the one cat on the first day was determined as a percentage. The percentages obtained were averaged based on the number of cats monitored to obtain the results on the first day.

On the second day, in the pet foods P and Q, contrary to the first day, one was fed from the right and the other was fed from the left at the same time. One cat was fed with the same feeding amount as on the first day, and the amount of the pet food eaten by the cat was measured when the cat completely ate one or after one hour. The result of the second day was obtained by the same calculation method as that of the first day.

Finally, the results of the first day and the second day were averaged to obtain the ratio “P:Q” of the amount of food intake for the pet food P to the amount of food intake for the pet food Q, which was the final result. As the numerical value of P or Q increased, it indicates that the cat as a monitor enjoyed eating the food. In a case where the value of P was greater than 5%, it means that the palatability was improved as compared with the pet food Q. The results are listed in the columns of “Palatability evaluation result” in Table 2.

TABLE 2

| | Test | Test | Test | Test | Comparative | Comparative |
|---|---|---|---|---|---|---|
| | Example 1 | Example 2 | Example 3 | Example 4 | Test Example 1 | Test Example 2 |
| Pet food granules | (1) | (1) | (1) | (1) | (2) | (2) |
| Set temperature (°C) | 25 (room | 37 | 37 | 37 | 25 (room | 37 |
| | temperature) | | | | temperature) | |
| Specific weight | 38 g/100 ml | 38 g/100 ml | 38 g/100 ml | 38 g/100 ml | 47 g/100 ml | 47 g/100 ml |
| Amount of granules (g) | 500 | 500 | 250 | 375 | 500 | 500 |
| Oil and fat exudation | 0.22 | 0.41 | 0.18 | 0.24 | 0.10 | 0.27 |
| amount (g) | | | | | | |
| Oil and fat exudation | 0.044% | 0.082% | 0.072% | 0.064% | 0.020% | 0.054% |
| rate (%): weight ratio | | | | | | |
| Palatability evaluation | 67:33 | | | | 44:56 | |
| result | | | | | | |

Based on the comparison between Test Example 1 and Comparative Test Example 1 as shown in the results in Table 2, it was confirmed that the pet food granules (1) had an exudation rate greater than that of the pet food granules (2) at 25 °C (room temperature).

Based on the comparison between Test Example 2 and Comparative Test Example 2, it was confirmed that the pet food granules (1) had an exudation rate greater than that of the pet food granules (2) at 37 °C.

Therefore, it is assumed that the oils and fats of the pet food granules (1) were likely to exude on the tongue of the cat (about 38 °C to 39 °C), and thus the palatability was increased.

In addition, as shown in the results listed in Table 2, it was confirmed that the pet food granules (1) had a relatively higher palatability than that of the pet food granules (2).

### [Production of Pet Food Granules (3)]

Pet food granules (3) were obtained in the same manner as in Example 1 except that the formulation of ingredients was changed as listed in Table 3.

TABLE 3

| | Pet food granules (3) |
|---|---|
| Formulation | mass (%) |
| Grains (wheat flour) | 35 |
| Grains (other grains) | 15 |
| Meat | 25 |
| Animal oils and fats | 10 |
| Yeasts | 7 |
| Seafood | 5 |
| Vitamins, minerals, and amino acids | 3 |

### [Evaluation of Color Difference Analysis]

Color difference analysis was performed on the following samples.
Specimen A: commercially available dry food (product name: Physicalife; manufactured by Unicharm Corporation)
Specimen B: pet food granules (1)
Specimen C: pet food granules (3)

Glass cells were filled with the samples, and measurement (n=5) was performed with a color difference meter while the positions of the glass cells were changed to determine L*a*b*. The results are listed in Table 4.

### (Measurement Conditions)

Device: SE7700 (manufactured by NIPPON DENSHOKU INDUSTRIES Co., Ltd.).
Light source: D65
Visual field: 2°

TABLE 4

| L* | | | | a* | | | | b* | | | |
|---|---|---|---|---|---|---|---|---|---|---|---|
| | Specimen | Specimen | Specimen | | Specimen | Specimen | Specimen | | Specimen | Specimen | Specimen |
| n | A | B | C | n | A | B | C | n | A | B | C |
| 1 | 34.7 | 25 | 20.5 | 1 | 7.8 | 10.9 | 8.9 | 1 | 23.9 | 17.9 | 11.6 |
| 2 | 34.8 | 25 | 20.6 | 2 | 7.9 | 10.9 | 9 | 2 | 23.9 | 17.6 | 11.7 |
| 3 | 34.8 | 25.2 | 20.7 | 3 | 7.8 | 10.9 | 9 | 3 | 23.9 | 17.7 | 11.8 |
| 4 | 34.7 | 25.1 | 20.6 | 4 | 7.8 | 11 | 8.9 | 4 | 23.8 | 17.9 | 11.5 |
| 5 | 34.8 | 25.1 | 20.5 | 5 | 7.8 | 11 | 9 | 5 | 23.8 | 17.8 | 11.4 |
| Ave. | 34.8 | 25.1 | 20.6 | Ave. | 7.8 | 10.9 | 9.0 | Ave. | 23.9 | 17.8 | 11.6 |
| Min. | 34.7 | 25 | 20.5 | Min. | 7.8 | 10.9 | 8.9 | Min. | 23.8 | 17.6 | 11.4 |
| Max. | 34.8 | 25.2 | 20.7 | Max. | 7.9 | 11 | 9 | Max. | 23.9 | 17.9 | 11.8 |

### [Component Analysis of Exuded Substance]

### (Observation of Appearance)

In “Evaluation of oil and fat exudation rate” described above, the filter paper of Test Example (2) obtained in (5) of (Measurement conditions) was visually observed as a specimen. As a result, the specimen was slightly yellowish as compared with the filter paper before the dry pet food was allowed to stand, and a small amount of light brown substance was found here and there,

### (Measurement (1) of Infrared Absorption Spectrum)

The specimen in “Observation of appearance” described above was extracted with ethyl acetate to obtain an ethyl acetate extract. The infrared absorption spectrum of the obtained ethyl acetate extract was measured.

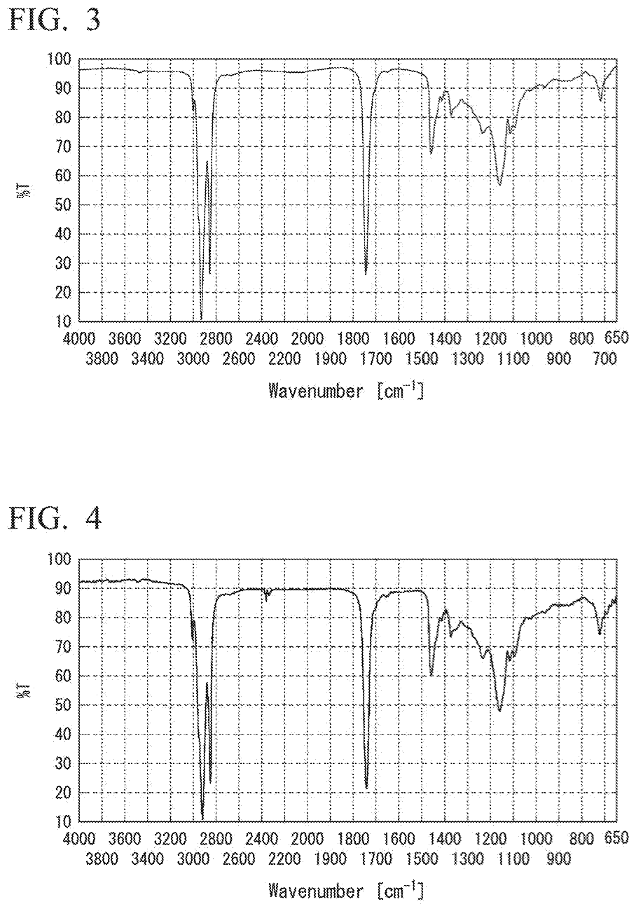

FIG. 3 is an infrared absorption spectrum of the ethyl acetate extract of the substance that has exuded on the surface of the pet food granules (1). FIG. 4 is an example of an infrared absorption spectrum of a triglyceride.

As shown in the results of FIG. 3, it was confirmed that the infrared absorption spectrum of the ethyl acetate extract of the specimen was similar to the infrared absorption spectrum of the triglyceride.

### (Measurement (2) of Infrared Absorption Spectrum)

In the specimen in “Observation of appearance” described above, the light brown substance was washed with water, air-dried, and extracted with ethyl acetate to obtain an ethyl acetate extract. The infrared absorption spectrum of the obtained ethyl acetate extract was measured.

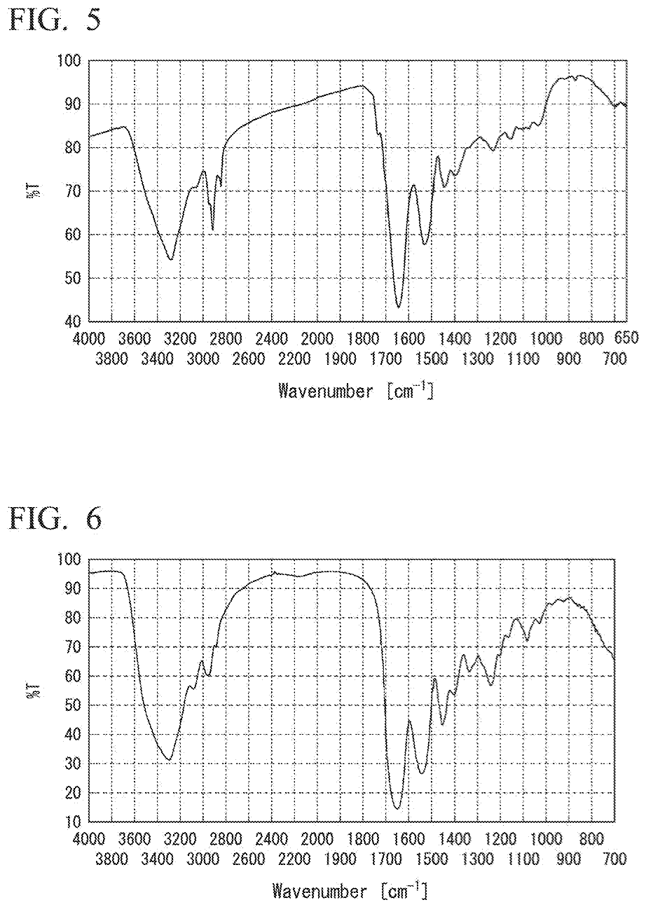

FIG. 5 is an infrared absorption spectrum of the ethyl acetate extract of the substance that has exuded on the surface of the pet food granules (1). FIG. 6 is an example of an infrared absorption spectrum of a protein.

As shown in the results of FIG. 5, it was confirmed that the infrared absorption spectrum of the ethyl acetate extract of the specimen was similar to the infrared absorption spectrum of the protein.

As shown in the results of the measurements (1) and 2) of the infrared absorption spectrum, it was confirmed that the substance that had exuded on the surface of the pet food granules (1) mainly contained a triglyceride and a protein.

While the preferred examples of the present invention have been described above, it should be understood that these are exemplary of the present invention and are not to be considered as limiting. Additions, omissions, substitutions, and other modifications can be made without departing from the scope of the present invention. Accordingly, the present invention is not limited by the description above but by the scope of the appended claims.

### REFERENCE SIGNS LIST

1 Food granule (pet food granule)
2 Kneaded material
11 Extruder (extrusion molding machine)
12 Die plate
12a First opening portion
12b Second opening portion
12c Minimum inner diameter portion
13 Cutting position

1. Dry pet food comprising:
puffed granules having a moisture content of 3% to 12% by mass,
wherein a content of oils and fats is 10% by mass or greater with respect to a total amount of the dry pet food, and
an oil and fat exudation rate on a surface of the dry pet food is 0.06% or greater under the following measurement conditions,
(measurement conditions)
(1) a mass of filter paper having a filter paper area of 420×600 mm² is measured,
(2) the filter paper is spread and placed on a plastic tray having outer dimensions of a width W of 705 mm, a depth D of 462 mm, and a height H of 57 mm,
(3) 500 g of the dry pet food is evenly spread and placed on the filter paper spread on the tray,
(4) the tray on which the dry pet food is placed is allowed to stand in an electric oven heated to 37 °C for 30 minutes,
(5) the tray is taken out from the electric oven, and the mass of the filter paper is measured, and
(6) the oil and fat exudation rate on the surface of the dry pet food is calculated from the following calculation formula,
oil and fat exudation rate (%) on surface of dry pet food=[(mass of filter paper measured in (5))−(mass of filter paper measured in (1))]/[mass of the dry pet food (500 g)×100.

2. The dry pet food according to claim 1,
wherein the puffed granules include granules having a surface with an arithmetic average surface roughness Sa of 14 μm or greater, which is measured using an L filter having a nesting index of 0.25 mm.

3. The dry pet food according to claim 1,
wherein the oils and fats have a melting point of 30 °C to 40 °C.

4. The dry pet food according to claim 1,
wherein a substance that exudes on the surface of the dry pet food contains at least one selected from the group consisting of a triglyceride and a protein.

5. The dry pet food according to claim 1,
wherein the dry pet food contains 3.0% by mass or greater of a powdery palatability improver with respect to the total amount of the dry pet food.

6. The dry pet food according to claim 1,
wherein an L* value in an L*a*b* color system is in a range of 21 to 33.

7. The dry pet food according to claim 2,
wherein the dry pet food contains 30% by mass or greater of wheat flour with respect to the total amount of the dry pet food.
